(19) United States
(12) Patent Application Publication
(10) Pub. No.: US 2013/0142250 A1
(43) Pub. Date: Jun. 6, 2013

(54) REGION BASED CLASSIFICATION AND ADAPTIVE RATE CONTROL METHOD AND APPARATUS

(71) Applicant: Gheorghe Berbecel, Irvine, CA (US)

(72) Inventor: Gheorghe Berbecel, Irvine, CA (US)

(73) Assignee: Broadcom Corporation, Irvine, CA (US)

(21) Appl. No.: 13/312,198

(22) Filed: Dec. 6, 2011

(51) Int. Cl. H04N 7/26

(52) U.S. Cl. 375/240.03; 375/240.02; 375/E07.126; 375/E07.139

(57) ABSTRACT

A system and method digital video encoding. The system may define encoding classes. The system may obtain a digital video picture and assign an encoding region of the digital video picture to an encoding class. The system may determine a bit rate parameter for the encoding region based on the encoding class.

### BACKGROUND

1. Field of the Invention

This application generally relates to a system and method for region based classification and adaptive rate control.

2. Description of Related Art

Encoding systems individually compress video pictures (e.g., the pictures that make up a stream of video) for efficient transmission. To that end, many systems control the bit rate available for compression for each video picture by attempting to evenly distribute the number of bits available. However, controlling the bit rate to provide an even distribution of bits does not always result in the best visual quality of the video pictures, as perceived by the viewer.

### BRIEF DESCRIPTION OF THE DRAWINGS

The system may be better understood with reference to the following drawings and description. In the figures, like reference numerals designate corresponding parts throughout the different views.

FIG. 1 is block diagram of a system for encoding an image;

FIG. 2 is an example image of a scene to be coded;

FIG. 3 is a mapping of quantizer values generated by a rate control method that evenly distributes bits;

FIG. 4 is a map of visual quality for the example image having the quantizer values as shown in FIG. 3;

FIG. 5 is a map of the desired visual quality for each macroblock.

FIG. 6 is a map of quantizer values that would produce a constant visual quality as shown in FIG. 5;

FIGS. 7A-C are graphs illustrating the relationship of the quantizer value for a macroblock relative to various macroblock characteristics to produce consistent visually quality;

FIG. 8 is a flow diagram of rate control logic for classifying each macroblock based on the parameters for that macroblock;

FIG. 9 is a map that illustrates the partitioning of the image of FIG. 2 into classes of macroblocks; and

FIG. 10 is a block diagram of one example of a system that implements the techniques described below.

### DETAILED DESCRIPTION

The system described herein controls the bit rate of compressed bit streams such that the scene in the video picture is classified into regions based on each region's properties. The properties may include motion, luminance, variance, picture type, spatial activity, or other properties. Furthermore, the system may determine the quantization of each region in such a way that the perceived visual quality will be better and more consistent from one region to another. More generally, the system implements rate control logic that improves video picture encoding to provide better quality and more consistent appearance from one picture to the next. The rate control logic may be implemented in software and stored in memory such that the processor executes the rate control logic to perform the method. However, it is also understood that the rate control logic can be implemented hardware such as an application specific integrated circuit, or a mix of both hardware and software.

As an overview, the system may classify each macroblock in an image into a number of predefined classes. The system may determine a quantizer for a macroblock in each class that is tailored in accordance with characteristics the human visual system. The system may accomplish this by mapping regional scene attributes to perceived quality characteristics.

Some aspects of the system can be implemented in a video compression system. One aspect of rate control is the bit-allocation for each frame and for each macroblock (MB) within the frame. As a baseline, the system may divide the total number of bits by the number of macroblocks to determine the ratio of bits to macroblocks. The system may then choose the baseline quantizer value for each macroblock based on the ratio.

The system may process any desired video format. For example, the system may process a high definition (HD) 1920×1080 progressive 60 Hz video stream. If the system implements 24 bits per pixel, the bit rate may be, as one example, on the order of 20 Mbits per second. Further, in the video may include any number of different frame types, such as intraframe (I), predicted (P), and bidirectional (B). In some implementations, the system may process a repeating group of pictures (GOP) structure of I P P P I P P P I. However, the system may process any other frame structure, as well. The system may allocate bits to I and P frames based on the ratio between the number of I and P frames. Further, the system may determine bit budgets for I and P frames such that the system allocates a different number of bits to I frames than to P frames.

However, the system may extract macroblock characteristic information from each macroblock, and use the macroblock characteristic information to make an allocation of bits to the macroblocks. Examples of macroblock characteristic information include motion, variance, and spatial activity. The spatial activity, for example, may be determined as a sum of the absolute values between a pixel and some of its neighboring pixels. The system may perform a classification based on the macroblock characteristic information and change the number of bits that are allocated to each macroblock. The bits may be allocated based on a model that takes into account how the human eye perceives the quantization noise in cases such as static areas of a frame, areas with panning content, or areas with arbitrary motion.

In addition, the system may perform macroblock classification based on the macroblock characteristic information, such as motion, variance and spatial activity. The system may then determine the quantization parameter for each macroblock based on the class that the macroblock is assigned, and further based on a model that may be derived from the characteristics of the Human Visual System (HVS) (although other models or combinations of models are also possible). The processing noted above helps the system improve the visual quality of the picture that includes the macroblock, and avoids over-allocating bits when it is not necessary (e.g., when a macroblock has a nearly constant luminance and close to a white level). Instead, the system allocates more bits to macroblocks that benefit from additional bits, such as macroblocks in a middle range gray with high spatial frequency content.

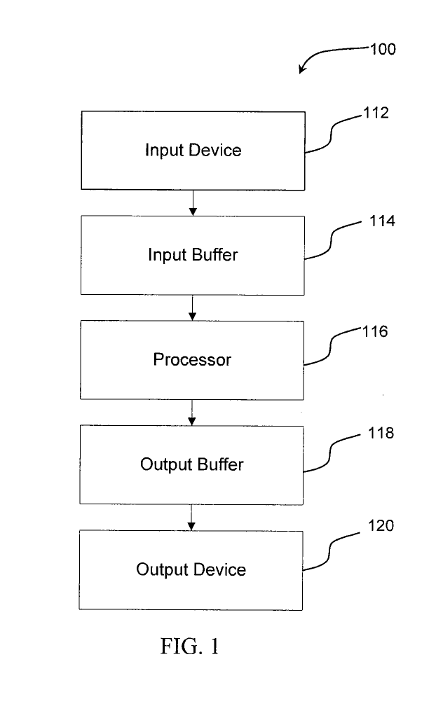

FIG. 1 shows a system 100 for digital video encoding. The system 100 includes a processor 110, an input device 112, an input buffer 114, an output buffer 116, and an output device 118. The input device 112 may be a network connection, a tuner, or a video input device such as a DVD player, a digital video recorder, a Blu-Ray player, a digital streaming device, or other similar devices that provide a digital video stream as an output for encoding in the system 100. The digital video may be provided from the input device 112 to an input buffer 114 that may store multiple frames of raw or processed video from the input device 112.

The processor 110 may receive the video frames from the input buffer 114 and perform various video processing operations on the video data. In this regard, the processor 110 may be in communication with a memory that stores a rate control or other program executed by the processor to perform the bit allocation techniques. Alternatively or additionally, the rate control algorithm of the processor 110 may be implemented in hardware only.

The processor 110 may access the video frames successively or process multiple time shifted frames together for encoding as discussed further below. The processor 110 may encode the video from the input buffer. In addition to the video encoding functions described here, the processor 110 may add frames or manipulate certain regions of the image to provide enhanced spatial or frequency information to the output video stream according to the parameters of the output device 118. The processor 110 may provide the video output to an output buffer 116. The output device 118 may receive the video output from the processor 110 through the output buffer 116. The output device 118 may be a network connection, transmitter, display device such as an HD television, 3D television, or other video output device.

FIG. 2 shows an example scene 200 that the processor 110 may encode. The scene 200, in this example, includes a cloudy sky 210, a grass field 212 generally located below the cloudy sky 210, a fast moving train 214 and a tree 216. Of course, video frames that the system 100 processes may include any content.

In this example, the cloudy sky 210 may be relatively static, shaded grey, and have slow variation from pixel to pixel. The grass field 212 may also be relatively static, but may include high spatial frequencies with sudden changes from pixel to pixel. The fast moving train 214 includes quickly moving shapes that are generally moving in the same direction. The tree 216 may include some slowly moving objects (e.g., leaves or branches) that may also have high spatial frequencies.

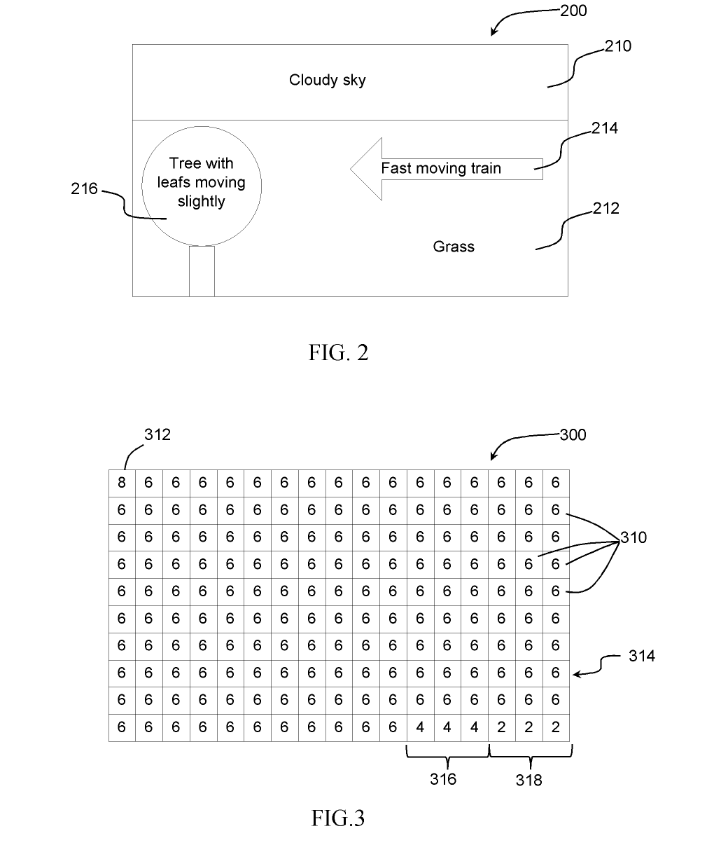

Now referring to FIG. 3, a map illustrating one implementation of baseline quantizer values is provided. The map 300 includes multiple regions, some of which are denoted by reference numeral 310. Each of the regions may be macroblocks of the image 300. In some implementations, the macroblocks may include a two dimensional array of 16×16 pixels, but macroblocks may be of any size or shape. The baseline quantizer value is denoted by the value within each region of the image 300. As will be described in more detail below, the system 100 may adjust the baseline quantizer value to tailor the bit allocation for any given macroblock. The baseline quantizer value may be assigned according to the desired output bit rate, a predetermined bit rate parameter stored in the memory, a bit rate provided by the video input device 112, or any other identified bit rate. The baseline for the quantizer value may approximate an equal distribution of bits by dividing the bit rate equally among each of the macroblocks. Accordingly, it can be seen that most of the macroblocks have an equal quantizer value. The first region 312, however, may use a slightly larger quantizer to assure that enough bits are provided throughout the rest of the image. Once the number of bits stabilizes the selected quantizer value averages out among the macroblocks. As such, the consistent quantizer continues through the middle portion of the image 314 until the end of the image is reached. Toward the end of the image, the quantizer value may be adjusted up or down based on the bit rate and bits utilized by each region. As such, a group of regions 316, toward the end of the image, have a slightly smaller quantizer value to adjust for additional bits. Similarly, group 318 is adjusted again at the very end of the image 300.

A system that generates a map like that shown in FIG. 3 tracks how many bits were produced for each macroblock on that picture up to the current macroblock in the scan order. The system may then adjust the quantizer up or down based on a comparison of the bit balance with the bit budget up to the current macroblock. If an excess of bits were utilized, the quantizer may be increased to generate less bits. If there was a deficit of bits, the quantizer may be decreased to produce more bits and improve the bit balance. At each macroblock, the change may be made with little or no consideration for the video content of that macroblock, which produces a very uniform map of the quantizer values.

The number in each region (e.g. macroblock) represents a quantizer value. The scale was arbitrarily chosen to be 0-9 merely to illustrate the principles of the system. The higher the quantizer is for each macroblock, the more coding errors will be present because fewer bits are allocated to the macroblock. The system may determine the remaining bit budged after a certain number of regions (e.g., 20 macroblocks). The system may adjust the number of bits up or down based on the remaining bit budget and the expected bits for the remaining number of macroblocks. In some implementations, the decision to change the quantizer may be based on a linear model. The system may adjust the number of bits, such that, the entire bit budget will be utilized by the end of the frame.

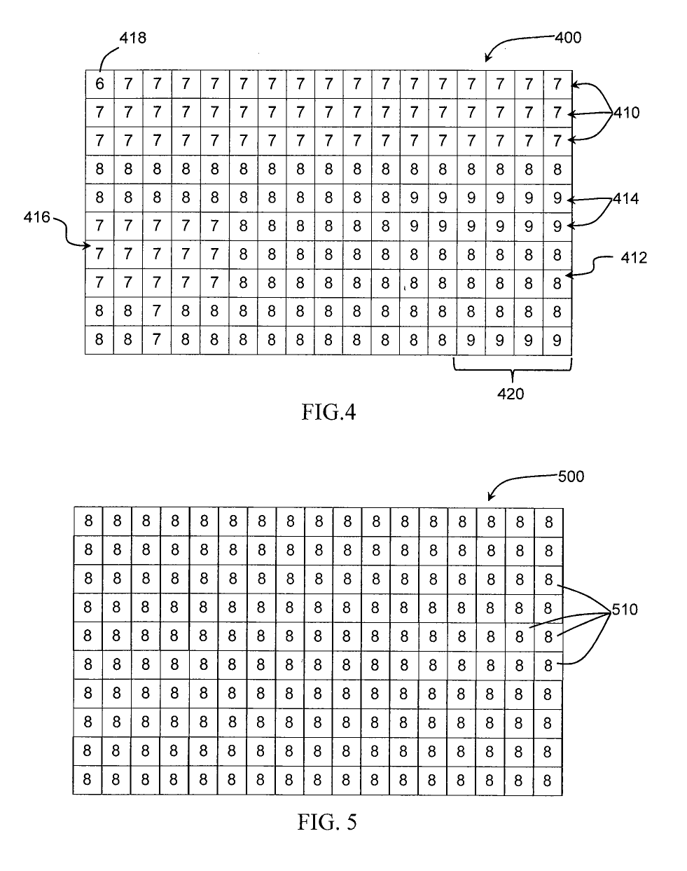

Now referring to FIG. 4, a map of the visual quality is illustrated for the picture of FIG. 2, when only the baseline quantizers provided in FIG. 3 are utilized. In FIG. 4, the higher values correspond to better visual quality. However, as can be realized after detailed analysis, the good, consistent visual quality may not result when only using the baseline quantizer values. The first region 418 has slightly less quality due to the higher quantizer value assigned to that region. The regions denoted by arrows 410 represent the cloudy sky and have a visual quality rating of seven. The region denoted by arrow 412 is the grassy background and has a visual quality rating of eight. The region that corresponds to the quickly moving train is denoted by lines 414 and has the highest visual quality rating of nine. Finally, the region indicated by arrow 416 represents the region containing the tree with slightly moving leaves and has a visual quality rating of seven. Further, a small group 420 of regions at the very end of the image 400 also has an improved visual quality of nine, due to the lower quantizer value in that region.

A comparison of FIG. 3 and FIG. 4 reveals that similar values of quantizer may result in very different visual quality. The sky has contrasting quantizer and quality values. Because of the dark grey of the clouds and because of the slow change from pixel to pixel, a macroblock pattern is noticeable in this region. When the content changes to the grass, the same quantizer produces better quality and the macroblock pattern is not very noticeable. For the area where the train is moving, the quality is very good, because motion can partially hide the encoding artifacts. This variability of the visual quality from one macroblock to another macroblock may be noticeable and very annoying to the viewer.

To improve image quality above that provided from the baseline quantizer with respect to FIGS. 3 and 4, the present system may be configured to reduce variability between macroblocks. For example, instead of producing a smooth and relatively constant quantizer, the system may produce a consistent visual quality across all or part of the picture. Accordingly, the system may determine the expected quality that will be realized by using a quantization map. This technique may also account for changes from frame to frame. For example, in some systems an I frame may be provided every 30 frames, so the variability experienced between the I frame and a P frame every ½ second may cause a pulsing effect, which can be very annoying to the viewer.

Now referring to FIG. 5, a representation of a desired visual quality for each macroblock is provided. As one can realize from FIG. 5, each of the macroblocks has a consistent visual quality as perceived by the viewer. For the purposes of explanation, all of the macroblocks 510 of the image 500 have a visual quality of eight. Providing a consistent visual quality for the macroblocks in the picture helps eliminate the quality issues identified above with respect to FIGS. 2 and 3, resulting in a better viewing experience.

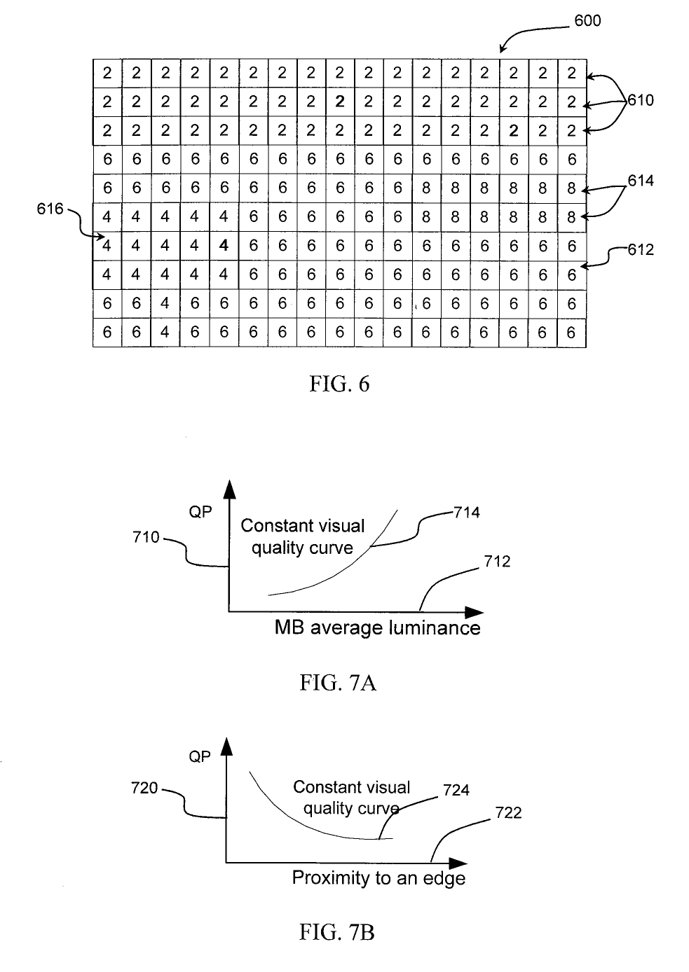

Now referring to FIG. 6, a map is provided of the quantizer value for each macroblock that would produce a constant visual quality for the image in FIG. 1. In the quantizer map 600, the line 610 represents the macroblocks that include the cloudy sky. Macroblocks 610 have a quantizer value of two. Macroblocks 612 have a quantizer value of six and represent the macroblocks including the grassy field. In addition, the macroblocks indicated by arrow 614 have a quantizer value of eight and correspond to the speeding train. Finally, the macroblocks indicated by line 616 have a quantizer value of four and represent the macroblocks including the tree with slightly moving leaves. Again, the quantizer values are for the sake of explanation only and are chosen from a scale of 0-9.

The system 100 generates a quantizer on a macroblock-by-macroblock basis taking into account the content of that macroblock. For the sky, where there is a slow change in content from pixel to pixel, a lower quantizer value helps capture the image detail that will result in a perceived consistent level of quality. The motion of the moving train would hide some encoding errors. Therefore, the system may increase the quantizer for the moving train, allowing more bits for other regions. The system 100 may allocate additional bits to the grass, for example, which is static and has a high spatial frequency. The system 100 may generate the values of the quantizer based on the encoding parameters and based on the content of the video being encoded. As such, the system may use a model to identify the quantizer needed to achieve desired quality in each macroblock. Further, all pixels in a macroblock may be assigned the same quantizer value.

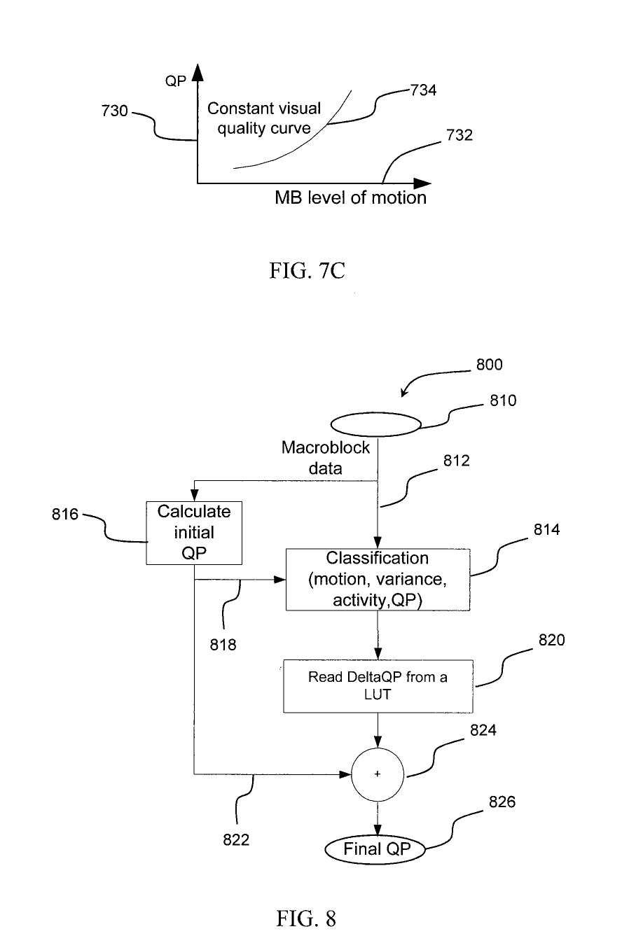

FIGS. 7A-7C illustrate 3 examples of how the system 100 may adjust the quantizer values in order to generate a consistent visual quality. The present system may determine the quantizer values depending on the value of various characteristics of each region. Visual quality is perceived by the user and is a function of such things as spatial frequency and motion in the regions. The relationships mapping the region characteristics to quantizer values may reflect measured, estimated, or predicted characteristics of the human visual system, such that, for example, smaller quantizer values (and therefore more bits) are assigned to regions that need better encoding to maintain a consistent visual quality level. The relationships may be monotonically increasing or decreasing relationships, may be linear or non-linear relationships, may be continuous or discontinuous, or have other mathematical properties. The relationships may correspond to how the human eye perceives the visual stimulus that is presented to it, and as a result, the bit allocation that will help capture the detail to maintain a desired quality level in the video images. For example, a bright item on darker background will be perceived more clearly by the eye than a dark item on a bright background.

Now referring to FIG. 7A, a visual quality curve 714 is provided that relates a quantizer value along the axis 710 to the average luminance of the macroblock along axis 712. As such, the relationship defined by curve 714 indicates the quantizer value that helps achieve a certain average luminance to provide a consistent visual quality. In general, the quantizer value increases with the average luminance of the macroblock.

Now referring to FIG. 7B, a visual quality curve 724 is provided that relates a quantizer value along the axis 720 to the edge proximity of the region to an edge of the overall image frame along axis 722. As such, the relationship defined by curve 724 indicates the quantizer value that helps achieve a consistent visual quality. In general, the quantizer value decreases as the edge proximity increases (For example, edge proximity may be closeness of features from the edge of the macroblock get smaller or number of features at the edge of the macroblock increases).

Now referring to FIG. 7C, a visual quality curve 734 is provided that relates a quantizer value along the axis 730 to the level of motion within the macroblock along axis 732. As such, the relationship defined by curve 734 indicates the quantizer value that helps achieve a certain level of motion to provide a constant visual quality. In general, the quantizer value increases with increased amount of motion because, e.g., fast motion tends to hide image artifacts from the human eye, and fewer bits are needed to encode the macroblock.

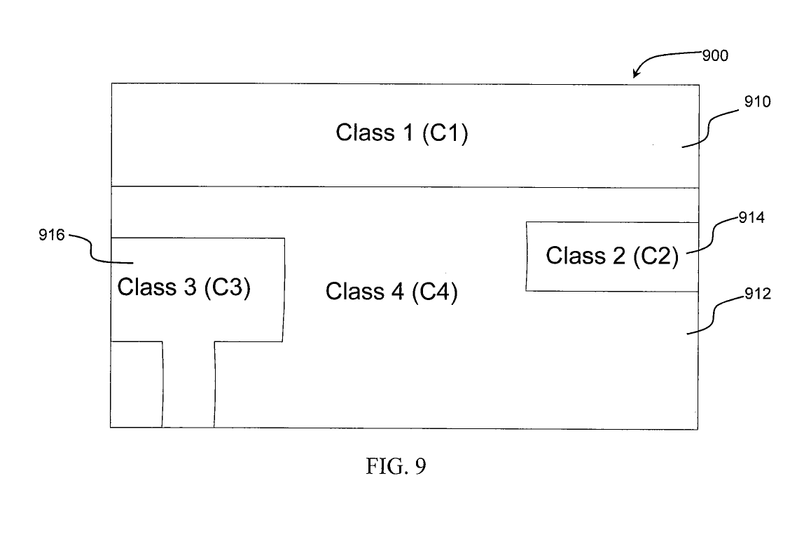

FIG. 8 is a flow diagram of the rate control logic that the processor 110 may execute to classify each region (e.g., macroblock) based on the characteristics for that region. To accommodate the difference in characteristics for each region, the rate control logic may adjust the baseline quantizer. In one implementation, the rate control logic may add or subtract a value to the baseline quantizer to make the adjustment.

In the example shown in FIG. 8, the variable DeltaQP represents the value used to adjust the baseline quantizer. The rate control logic may determine DeltaQP according to an encoding class that the rate control logic assigns to a region based on the characteristics for that region. In some implementations, the rate control logic may read DeltaQP from a look-up table that is indexed by encoding class. The DeltaQP for each classification may be determined such that the same or about the same visual quality would be produced as for the neighboring macroblocks. The rate control logic may determine the quantizer for that macroblock as a sum of the baseline quantizer and DeltaQP. Further, the rate control logic may scale DeltaQP based on the overall bit rate or the total bit budget for the frame that includes the macroblock under consideration.

One implementation of the rate control logic 800 starts at (810) where the rate control logic provides the macroblock data 812 to both (814) and (816). At (816), the rate control logic determines a baseline quantizer value. The rate control logic may determine the baseline quantizer value as described in accordance with FIG. 3. The rate control logic may provide the baseline quantizer value to (814), as denoted by the logic flow 818. The rate control logic uses the macroblock data 812 and the baseline quantizer values, as denoted by line 818, to perform a classification of each region (e.g., macroblock).

The classification may be based on the region variables such as the baseline quantizer value, the motion within the region, the variance of the region, activity within the region, luminance of the region, the proximity of the region to an edge, as well as any combination of these and other characteristics. The rate control logic may monitor the region characteristics for each region. Each characteristic may have a defined range of values that the rate control logic monitors. For example, luminance may vary from 0 to 255, and motion vectors may vary from −128 to 127, as measured by any existing image analysis techniques for determining such characteristics.

The rate control logic may segment any range of characteristic into subranges or bins that help determine which encoding class the macroblock belongs to. For example, the rate control logic may segment the luminance range into 16 bins each spanning a subrange of 16 values (e.g., 0 to 15; 16 to 31; . . . 240 to 255). The bins from each characteristic may then form a one or multidimensional space of encoding classes to which the rate control logic assigns the macroblocks. Bins may be as coarse or as fine as desired for any particular implementation, and the one or multidimensional space may cover as many or as few characteristics as desired, to create as many or as few bins and encoding classes as desired. As one example, a macroblock that falls in luminance bin 3 of 8, motion bin 5 of 8, and edge proximity bin 2 of 4 may be assigned to the encoding class (3, 5, 2) out of 256 possible classes (any number of which may result in the same quantizer value for a macroblock). As another example, where luminance is the only characteristic considered, the macroblock may be assigned to one of sixteen classes, with each encoding class corresponding to one of the sixteen bins. As another example, the rate control logic may define eight encoding classes corresponding to: 1) medium or low luminance; 2) static or slow moving areas; and 3) flat or medium spatial frequency (i.e., 2 bins for each of three characteristics, or 8 total combinations). Also, because there is typically a correlation from picture to picture, the macroblock classification may be similar from frame to frame and the classification from the previous frame in time may be used as a starting point in an attempt to perform the macroblock classification. Accordingly, either the baseline quantizer value or the class quantizer value for the digital video picture may be based on a quantizer value from a previous digital video picture in a series of digital video pictures

The classification for each block is thus identified (814) and provided to (820). The processor 110 may use the classification for each macroblock in (820) to determine a class quantizer value, for example from a lookup table. The class quantizer value may be a quantizer offset that the rate control logic may add to the baseline quantizer value for the current frame.

The baseline quantizer value, as noted by line 822, and the class quantizer value (e.g., DeltaQP) from step 820 are provided to (824). The rate control logic at (824) may then combine the baseline quantizer value with the class quantizer value based on any of a number of functional relationships. In one implementation, the rate control logic adds the class quantizer value to the baseline quantizer value. The rate control logic may then output the final quantizer value for the macroblock, (826). In other words, the rate control logic may determine the region quantizer value based on the baseline quantizer value and the class quantizer value. In one implementation, the rate control logic may determine the quantizer value as a sum of a first value based on the baseline quantizer and a second value based on the class quantizer. For example, the sum may be defined as A*baseline quantizer+B*class quantizer, where A and B are constants. The rate control logic, through this classification processes, helps adapt bit rate allocation to macroblocks according to the way that the human visual system responds to image characteristics of the macroblocks, and thereby help ensure consistently good image quality throughout the image.

FIG. 9 is a map 900 illustrating how the rate control logic partitions the image of FIG. 2 into classes of macroblocks. The rate control logic thereby provides each macroblock with its own bit budget and resultant image quality characteristics. The map 900 includes four classes that the rate control logic identified in the image of FIG. 2. Class one, denoted by reference numeral 910, corresponds to the cloudy sky. Reference numeral 912, corresponds to class four, which may represent the grassy fields. Similarly, reference numeral 914 may correspond to class two, which includes the fast moving train. Lastly, reference numeral 916 corresponds to class three representing the tree with the slightly moving leaves.

The rate control logic may determine the classification based on the current video frames, prior video frames, or based on both the current and prior video frames. Once the rate control logic determines the classification, the rate control logic may allocate bit budget B to each class. The rate control logic may request that a number of bits are generated for each class, B1 (for class C1), B2 (for the class C2), B3 (for the class C3) and B4 (for the class C4), such that the relationship:

B=B1+B2+B3+B4;

is preserved. Accordingly, a target number of bits for the digital video picture may be allocated to each class before starting the encoding process such that a sum of allocated bits for classes is equal to the target number of bits B in the bit budget for the digital video picture.

By allocating the bits according to class, the rate control logic may independently manage each class of macroblocks. In particular, the rate control logic may determine to allocate additional bits, or deallocate bits from each class separately. In other words, the rate control logic is not limited to an approximately even allocation of bits over the entire frame.

The present system allocates bits for each video picture in connection with content on a macroblock-by-macroblock basis. For example, the present system may identify, in a video picture, alternating areas of static blue sky in the background, slowly moving leaves in the foreground and a fast moving train in the middle. The present system may then assign tailored quantizer values to each macroblock to eliminate visible periodic patterns on the sky, so called “I” (intra-coded) pulsing on the leaves, and unnecessarily good quality on the fast moving train. As noted above, the present system improves image quality in these examples by differentiating content in the macroblocks according to how the human visual system experiences the content. The present system classifies each macroblock of the picture into an encoding class and derives a quantizer value for each macroblock that may be responsive to the characteristics of the human visual system. The result is an image with approximately consistent image quality throughout the image (e.g., among all the macroblocks).

The systems and methods described may be applied to all types of pictures, to all existing encoding standards, and to any possible future video encoding standards. These methods are widely applicable to compensate during the macroblock quantization process for the characteristics of the human visual system. These methods are also very powerful because any process trying to provide constant visual quality perception could use these methods to compensate for the characteristics of the human visual system.

In another implementation, the present system may apply the classification and quantization determination techniques identified above to multiple video streams that are contemporaneously encoded. For example, a PAP (Picture And Picture) system may utilize the techniques to provide uniform video quality across the multiple video streams. In this scenario, the system may allocate selected macroblocks to a selected video stream while allocating other macroblocks to a different video stream. Accordingly, the quantizer value for each macroblock may be selected to provide a consistent video quality across both video streams. Accordingly, the process may be implemented in the same manner as described above.

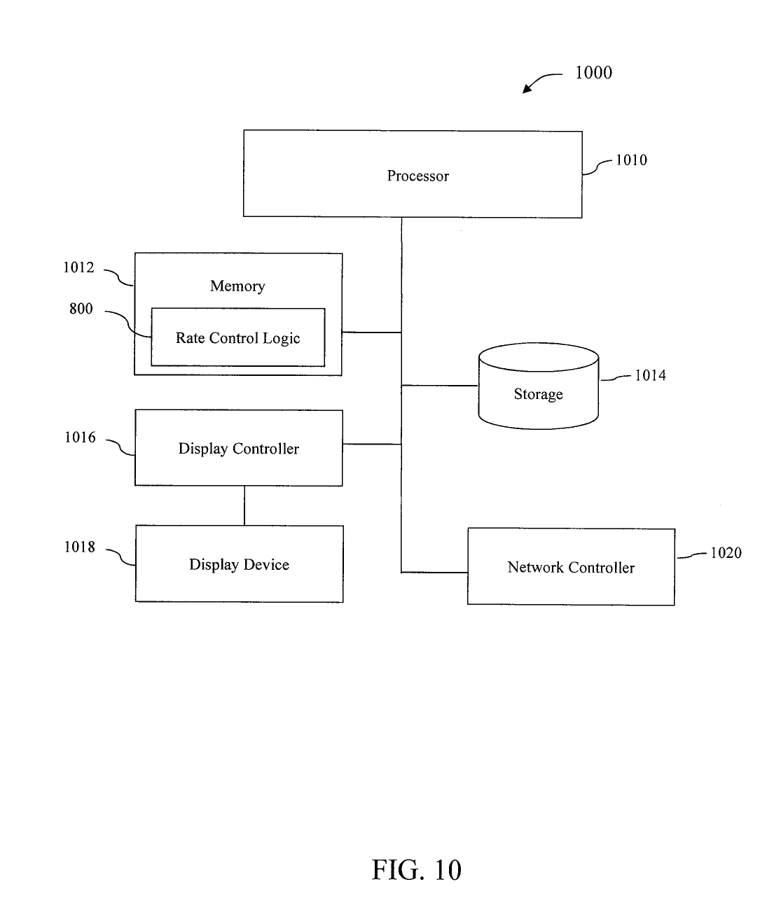

Any of the modules, systems, or methods described may be implemented in one or more integrated circuits or processor systems. One exemplary system is provided in FIG. 10. The processing system 1000 includes a processor 1010 for executing instructions such as those described above (e.g., with respect to the rate control logic 800). The instructions may be stored in a computer readable medium such as memory 1012 or storage devices 1014, for example a disk drive, CD, or DVD. The computer may include a display controller 1016 responsive to instructions to generate a textual or graphical display on a display device 1018, for example a computer monitor. In addition, the processor 1010 may communicate with a network controller 1020 to communicate data or instructions to other systems, for example other general computer systems. The network controller 1020 may communicate over Ethernet or other known protocols to distribute processing or provide remote access to information over a variety of network topologies, including local area networks, wide area networks, the Internet, or other commonly used network topologies.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the present system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the method and system have been described, it will be apparent to those of ordinary skill in the art that many more embodiments and implementations are possible within the scope of the system and method. Accordingly, the system and method are not to be restricted except in light of the attached claims and their equivalents.

As a person skilled in the art will readily appreciate, the above description is meant as an illustration of the principles of this application. This description is not intended to limit the scope of this application in that the system is susceptible to modification, variation and change, without departing from spirit of this application, as defined in the following claims.

What is claimed is:

1. A method for digital video encoding, the method comprising:
defining encoding classes;
obtaining a digital video picture comprising an encoding region;
assigning the encoding region to a selected encoding class among the encoding classes; and
determining a bit rate parameter for the encoding region based on the selected encoding class.

2. The method according to claim 1, wherein the encoding region comprises a macroblock.

3. The method according to claim 2, wherein the bit rate parameter comprises a region quantizer value.

4. The method according to claim 1, further comprising calculating a baseline quantizer value for the encoding region based on a number of regions in the digital video picture, the region quantizer value being calculated based on the baseline quantizer value.

5. The method according to claim 4, further comprising assigning a class quantizer value to the encoding class and calculating the region quantizer value based on the baseline quantizer value and the class quantizer value.

6. The method according to claim 5, further comprising calculating the region quantizer value as a sum of a first value based on the baseline quantizer value and a second value based on the class quantizer value.

7. The method according to claim 5, further comprising calculating the region quantizer value based on a sum of the baseline quantizer value and the class quantizer value.

8. The method according to claim 5, further comprising retrieving the class quantizer value from a look-up-table for each class.

9. The method according to claim 8, wherein the look-up-table implements human visual system characteristics.

10. The method according to claim 9, wherein the look-up-table implements human visual system characteristics according to a monotonic function.

11. The method according to claim 4, wherein the digital video picture is one of a series of digital video pictures and the baseline quantizer value for the digital video picture is based on a previous quantizer value from a previous digital video picture in the series of digital video pictures.

12. The method according to claim 1, furthering comprising assigning the encoding region to the encoding class based on luminance, variance, motion vectors, edge proximity, or any combination thereof.

13. A system for digital video encoding, the system comprising:
a processor; and
a memory in communication with the processor, the memory comprising rate control logic that, when executed by the processor, causes the processor to:
define encoding classes;
obtain a digital video picture comprising macroblocks;
assign each macroblock to a selected encoding class among the encoding classes;
determine a region quantizer value for each macroblock based on the selected encoding class by determining a baseline quantizer value for each macroblock and a class quantizer value assigned to each encoding class, the region quantizer value determining bit rates for the macroblocks.

14. The system according to claim 13, where the rate control logic further causes the processor to:
assign each macroblock according to macroblock characteristics of the macroblocks.

15. The system of claim 14, where macroblock characteristics comprise:
luminance, variance, motion vectors, edge proximity, or any combination thereof.

16. The system according to claim 13, where the class quantizer value models human visual system characteristics according to a monotonic relationship.

17. The system according to claim 13, where the region quantizer value comprises a sum the baseline quantizer value and the class quantizer value.

18. A method for digital video encoding, the method comprising:
defining encoding classes;
obtaining a digital video picture comprising macroblocks;
assigning each macroblock to a selected encoding class among the plurality of encoding classes according to a macroblock characteristic comprising luminance, variance, motion vectors, edge proximity, or any combination thereof;
determining a baseline quantizer value for each macroblock;
determining a class quantizer value, assigned to each encoding class, that models human visual system characteristics; and
determining a region quantizer value for each macroblock as a sum of the baseline quantizer value and the class quantizer value, the region quantizer value determining bit rates assigned to the macroblocks.

19. The method of claim 18, where the class quantizer value models human visual system characteristics using a monotonically increasing function.

20. The method of claim 18, where the class quantizer value models human visual system characteristics using a monotonically decreasing function.
